(19) United States
(12) Patent Application Publication
(10) Pub. No.: US 2002/0186260 A1
(43) Pub. Date: Dec. 12, 2002

(54) Method and apparatus for display of access control in a graphical user interface

(75) Inventor: Neil George Stanley Young, Southampton (GB)

Correspondence Address: IBM Corp., IP Law, 11400 Burnett Road, Zip 4054, Austin, TX, 78758, US

(73) Assignee: International Business Machines Corporation, Armonk, NY

(21) Appl. No.: 10/132,398

(22) Filed: Apr. 25, 2002

(30) Foreign Application Priority Data
May 3, 2001 (GB) 0110825.7

(51) Int. Cl. G09G 5/00

(52) U.S. Cl. 345/853

(57) ABSTRACT

A method and apparatus for display of access control in a graphical user interface (100) is provided including displaying resources in a tree structure (102) having a plurality of nodes (104, 114, 120. . . ). Each node represents a resource and each resource has the potential for one or more users in relation to one or more actions on the resource. Permission to perform an action on a resource by a principal can be selectively displayed (134). The principal can be an individual user or a group of users. The result of a query relating to permission to perform an action on a specified resource for a principal (182) can be displayed on the tree structure (102).

### FIELD OF INVENTION

This invention relates to a method and apparatus for display of access control in a graphical user interface. In particular, the invention relates to display of access control or authorisation policies on resources in tree structures.

### BACKGROUND OF THE INVENTION

Tree structures are used to graphically represent hierarchical data in graphical user interfaces. Categories of data are represented in nodes of the tree structure. The tree structure starts with a root node which has a plurality of branches. Each branch can have lower branches ending in the lowest nodes which may be referred to as leaf nodes. In the hierarchical tree structure nodes are referred to as parent and child nodes to indicate their relationship within the tree structure.

Examples of resources that are stored in a tree structure include topics in a message broker for controlling the receipt and distribution of messages, entries in a lightweight directory access protocol (LDAP) repository or directories and files in a data communications equipment (DCE) cell. Resources are stored in tree structures in a wide range of applications.

For the purpose of illustration, the example of a resource tree structure for message topics in a message brokering system will be used. It should be appreciated that this is a specific example of a resource tree structure and other tree structures could equally be used.

A topic specifies a subject of common interest to producers and consumers of messages (publishers and subscribers). Almost any string of characters can act as a topic to describe the topic category of a message.

Topics provide the key to the delivery of messages between publishers and subscribers. They provide an anonymous alternative to citing specific destination addresses. The broker attempts to match a topic on a published message with a list of clients who have subscribed to that topic. Topics can also be used to control which subscribers are authorized to receive publications.

Thoughtful design of topic names and topic trees can save time for routine operations, including subscribing to multiple topics, establishing security policies, and automatically reacting to messages on a specific topic.

The structure of the tree follows a format with levels of increasing granularity, for example, “country/state/city”. FIG. 1 shows a tree structure 10. Each string in the topic name represents a node on the topic tree 10. Topic names fully specify the path to a specific node from the root of the tree in this format: “root/level2/level3”.

In FIG. 1, for example, the string “USA” acts as a root node 12, the first level of a topic name for topics in this tree 10. The strings representing states “Alabama” and “Alaska” are nodes at a second level 14 of the tree 10. The strings representing cities “Juneau”, “Auburn”, “Mobile” and “Montgomery” are nodes at a third level 16 of the tree 10. Valid topics include “USA”, “USA/Alabama” and “USA/Alabama/Montgomery”.

The set of topics registered by client applications with a message broking system creates a topic tree. Each topic in the tree may have an associated Access Control List (ACL) that determines who is able to publish, subscribe or request persistent delivery of messages on that topic. Since topics are organized in a tree, the Access Control List (ACL) of a parent topic may be inherited by some or all of its child topics. Furthermore, access control or authorisation policies may be defined for both individual users and for groups of users.

The ability of users to publish information, or subscribe to information depends on the setting of the Access Control Lists (ACLs). The ACLs are set on topics to which the message is published. Publishers must have ACL permission to publish to the required topic. Subscribers must have ACL permission to subscribe to the required topic. Subscribers may request to receive persistent messages, but if denied by the ACLs they will still receive the desired messages, but will not receive them persistently.

In the general case, the decision on whether a specific user may perform a specific operation on a specific topic requires a traversal from that topic to the root of the topic tree that collects the set of ACLs on intervening nodes that relate to the user, either directly or through membership of groups. The set of user related ACLs is then processed to determine the prevailing policy which, in turn, determines whether the user can perform the requested operation.

An explicit ACL can be created for any topic in the topic tree, up to and including the topic root. An ACL allows, denies, or inherits the authority to publish, to subscribe, and to request persistent message delivery. If any topic does not have an explicit ACL, it is governed by the ACL it inherits from its higher level (parent) topic in-the tree. The default ACL setting for the topic root is to allow public access. This can be modified to restrict access by introducing ACLs at specific points in the tree. This can mean that if a leaf topic does not explicitly state the ACL permissions then the ACLs are derived from the higher topics, ultimately using the root ACLs if no other ACLs have been found in the topic tree.

The determination of whether a specific user or principal may perform a specific operation can be difficult to determine from inspection of the Access Control Lists (ACLs) defined on the nodes in the tree. Furthermore, it can be difficult for an administrator to construct or amend the sets of ACLs in the tree to best reflect his/her organization's security policy in such a structure. The difficulty increases where resource trees are large, ACLs are inherited (from a node to its subtree), and where ACLs may be defined for groups of users as well as for specific users.

### DISCLOSURE OF THE INVENTION

The present invention describes a tool which provides a visual representation of such authorization policies. The key benefit of this tool is that the administrator is able to query operational permissions on a specific node in a resource tree and to understand how the resultant permission was derived through highlighting related Access Control Lists (ACLs) on the appropriate branch of the tree. Although the invention is described in terms of Access Control Lists, it will be understood by a person skilled in the art that the invention can be applied to any form of authorisation or permission policies applied to resources and the term access control should be interpreted accordingly.

According to a first aspect of the present invention there is provided a method for display of access control in a graphical user interface including: displaying resources in a tree structure having a plurality of nodes, each node representing a resource and each resource having the potential for one or more users in relation to one or more actions on the resource; and selectively displaying permission to perform an action on a resource by a principal at a node, wherein the principal is an individual user or a group of users.

Preferably, the method includes displaying the result of a query relating to permission to perform an action on a specified resource for a principal within the tree structure. The method may also include displaying how the result of the query was obtained.

Displaying the result of the query may include highlighting a branch of the tree structure including the node with the principal, the highlighting indicating the outcome of the result, for example in colour. The method may also include displaying access control lists for principals at all nodes on the highlighted branch.

Preferably, the method includes identifying by a first means the access control list that determines the outcome of the result of the query. Any principal related access control lists which do not determine the outcome of the result may be identified by a second means. The identifying by first and second means may be by means of highlighting, borders, colour, patterns or other means to distinguish from other access control list displays and wherein the first and second means are different.

Preferably, access control for principals is displayed with symbols indicating the status of the control permission for given activities relating to the resource. The symbols may be traffic lights with colour indications of the status of the control permission.

Preferably, the method includes running a runtime function to traverse the tree structure accumulating access control lists relating to the principal and choosing the determining access control list according to a set of predetermined rules. The predetermined rules may include inherited access control and specific access control rules.

The resources may be topics in a message broking system and access control may relate to the publishing and subscribing to messages.

According to a second aspect of the present invention there is provided an apparatus for display of access control in a graphical user interface including: a display of resources in a tree structure having a plurality of nodes, each node representing a resource and each resource having the potential for one or more users in relation to one or more actions on the resource; and means for selectively displaying permission to perform an action on a resource by a principal at a node, wherein the principal is an individual user or a group of users.

Preferably, means are provided for displaying the result of a query relating to permission to perform an action on a specified resource for a principal within the tree structure. The apparatus may include means for displaying how the result of the query was obtained. The means for displaying the result of the query may include a highlighted branch of the tree structure including the node with the principal, the highlighting indicating the outcome of the result. The apparatus may include a display of access control lists for principals at all nodes on the highlighted branch.

Preferably, the apparatus includes means for identifying by a first means the access control list that determines the outcome of the result of the query. Any principal related access control lists which do not determine the outcome of the result may be identified by a second means. The means for identifying by first and second means may be by means of highlighting, borders, colour, patterns or other means to distinguish from other access control list displays and wherein the first and second means are different.

Preferably, displays of access control for principals is in the form of symbols indicating the status of the control permission for given activities relating to the resource. The symbols may be traffic lights with colour indications of the status of the control permission.

Preferably, a runtime function is provided to traverse the tree structure accumulating access control lists relating to the principal and means for choosing the determining access control list according to a set of predetermined rules. The predetermined rules may include inherited access control and specific access control rules.

The resources may be topics in a message broking system and access control may relate to the publishing and subscribing to messages.

According to a third aspect of the present invention there is provided a computer program product stored on a computer readable storage medium comprising computer readable program code means for performing the steps of: displaying resources in a tree structure having a plurality of nodes, each node representing a resource and each resource having the potential for one or more users in relation to one or more actions on the resource; selectively displaying permission to perform an action on a resource by a principal at a node, wherein the principal is an individual users or a group of users.

### BRIEF DESCRIPTION OF THE DRAWINGS

An embodiment of the invention will now be described, by means of example only, with reference to the accompanying drawings in which:

FIG. 1 is a representation of a topic tree structure;

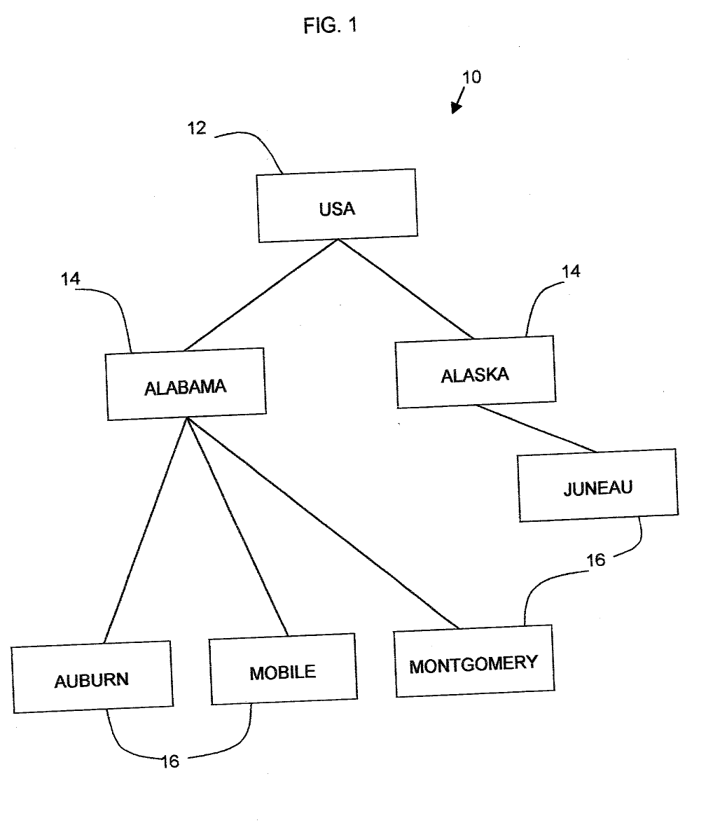

FIG. 2 is a representation of a topic tree showing Access Control Lists in a message broking system at selected nodes of the tree structure;

FIG. 3 is a representation of a topic tree structure in a graphical user interface in accordance with a preferred embodiment of the present invention;

FIG. 4 is a representation of a section of the topic tree structure of FIG. 3 with Access Control Lists defined for particular nodes in accordance with a preferred embodiment of the present invention;

FIG. 5 is a representation of a section of the topic tree structure of FIG. 3 with a dialogue box activated for a particular node of the tree structure in accordance with a preferred embodiment of the present invention; and

FIG. 6 is a representation of the topic tree structure of FIG. 3 with permission hierarchy illustrated in accordance with a preferred embodiment of the present invention.

### DESCRIPTION OF THE PREFERRED EMBODIMENTS

While the method and apparatus described herein has wider application, the described embodiment uses the specific example of the publish/subscribe component of the MQSeries® Integrator version2 Message Broking System of International Business Machines Corporation.

A message broking system controls the delivery of messages between publishers and subscribers of messages. The messages can be published and delivered according to topics of the messages. The topics are arranged in a topic tree structure.

Principals are defined as individual users or groups of users of the message broking system who publish and subscribe individually or in groups to the messages handled by the system. All defined principals can be associated with any topic. The permissions that can be set are shown below.

Option Description

Publish Permits or denies the principal to publish messages on this topic.

Subscribe Permits or denies the principal to subscribe to messages on this topic.

Persistent Specifies whether the principal can receive messages persistently. If the principal is not permitted, all messages are sent non-persistently. Each individual subscription indicates whether the subscriber requires persistent messages.

Persistent access control behaviour is not identical to the publish and subscribe control. Clients that are denied Publish access have their publication messages refused. Clients that are denied Subscribe access do not receive the publication. If persistent access is denied the system does not deny the message to subscribers, but does deny them persistence. Persistent denied subscribers receive messages (subject to their subscribe access control), but have the message sent to them non-persistently, regardless of the persistence of the original message.

Each topic in the tree may have an associated Access Control List (ACL) that determines which principals are able to publish, subscribe or request persistent delivery of messages on that topic.

Topics of messages are organized in a hierarchical tree. The Access Control Lists (ACLs) of a parent topic can be inherited by some or all of its descendent topics that do not have an explicit ACL. Therefore, it is not necessary to have an explicit ACL associated with each and every topic. Every topic has an ACL policy which is that of its parent. If all parent topics up to the root topic do not have explicit ACLs, that topic inherits the ACL of the root topic.

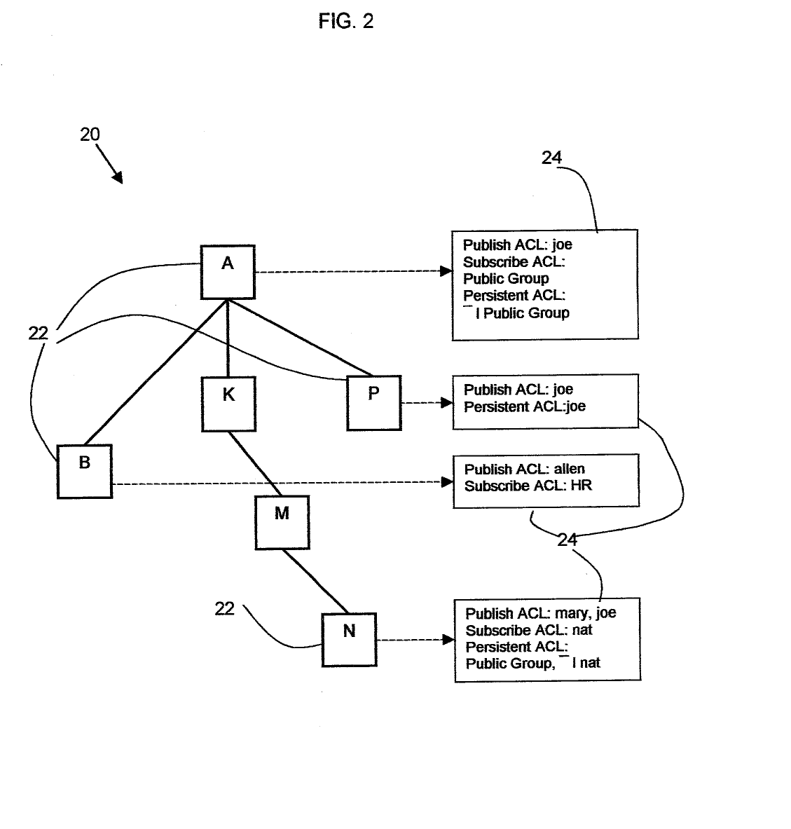

For example, in a topic tree 20 is illustrated in FIG. 2. The topic root is not shown but is assumed to have an ACL for Public Group access that allows permission to publish, subscribe, and receive persistent publications. The ACL permissions 24 are shown for selected topic nodes 22 in the tree 20. The table below summarizes the ACLs for each topic node 22 in the tree 20 shown.

| TOPIC | PUBLISHERS | SUBSCRIBERS | PERSISTENCE | COMMENTS |
|---|---|---|---|---|
| A | only joe | everyone | no-one | Explicit policy |
| A/P | only joe | everyone | only joe | Explicit policy, |
| | | | | but inheritance for |
| | | | | subscribe ACL |
| A/K | only joe | everyone | no-one | Policy through A |
| A/K/M | only joe | everyone | no-one | Policy through A/K |
| A/K/M/N | only mary, | everyone | everyone | Explicit policy |
| | joe | | except nat | |
| A/B | allen | HR | no-one | Persistent |
| | | | | inherited through A |

There is described a tool that allows an administrator to display the resources in the tree and their associated ACLs. It further allows the administrator to select a resource node in order to check whether a specific principal may perform a specific operation on that resource. The tool displays the result of the check, together with information on how that decision was reached. This information takes the form of:

Reporting whether the operation would be allowed or denied

Highlighting the relevant branch in the tree.

Displaying all the ACLs on that branch.

Highlighting the prevailing ACL whose policy determines the outcome.

“Lowlighting” other user related ACLs on the branch.

This information will help an administrator to better understand the effect of the ACLs that are defined on the tree and to construct a set of ACLs that meet an organization's security requirements. It could be used for security audits, training or problem determination.

The tool imports the full set of ACLs defined on all topics in a broker and graphically displays the topic tree. The tool operator is able to display the set of ACLs defined on a particular node. The displayed ACL shows a principal name (either an individual user or a group) together with a set of 3 “traffic light” symbols that show whether the principal is allowed (green) or denied (red) the right to publish, subscribe or receive persistent messages on that topic. If the symbol is greyed out, then the ACL does not specify a permission for that operation.

When an operator selects the “operations” button on a node he is presented with a dialog that allows him to query the permission of a principal to perform an operation on the topic associated with the node. The query is performed by driving a subset of MQSeries Integrator v2 runtime function that traverses the tree, accumulating related ACLs and chooses the prevailing ACL according to a set of MQSeries Integrator v2 rules. The result of the query is presented as follows,

A dialog reports whether the operation would be allowed or denied.

The relevant branch in the tree is highlighted in green (allowed) or red (denied).

All the ACLs on that branch are displayed.

The prevailing ACL whose policy determines the outcome of the operation is highlighted with a gold border and a bright red or green as appropriate. This prevailing ACL might be on any of the nodes in the relevant branch.

Other ACLs that are related to the permissions check are “lowlighted”. For example the user might be a member of a group that has an ACL on a node that is closer to the root node than the prevailing ACL's node. Such an ACL would be lowlighted in a dull red or green as appropriate.

A related ACL that is greyed-out for the specific operation is given a red and green border.

The analysis of this set of information will allow an administrator to better understand and to better construct the ACLs on their organization's topic tree.

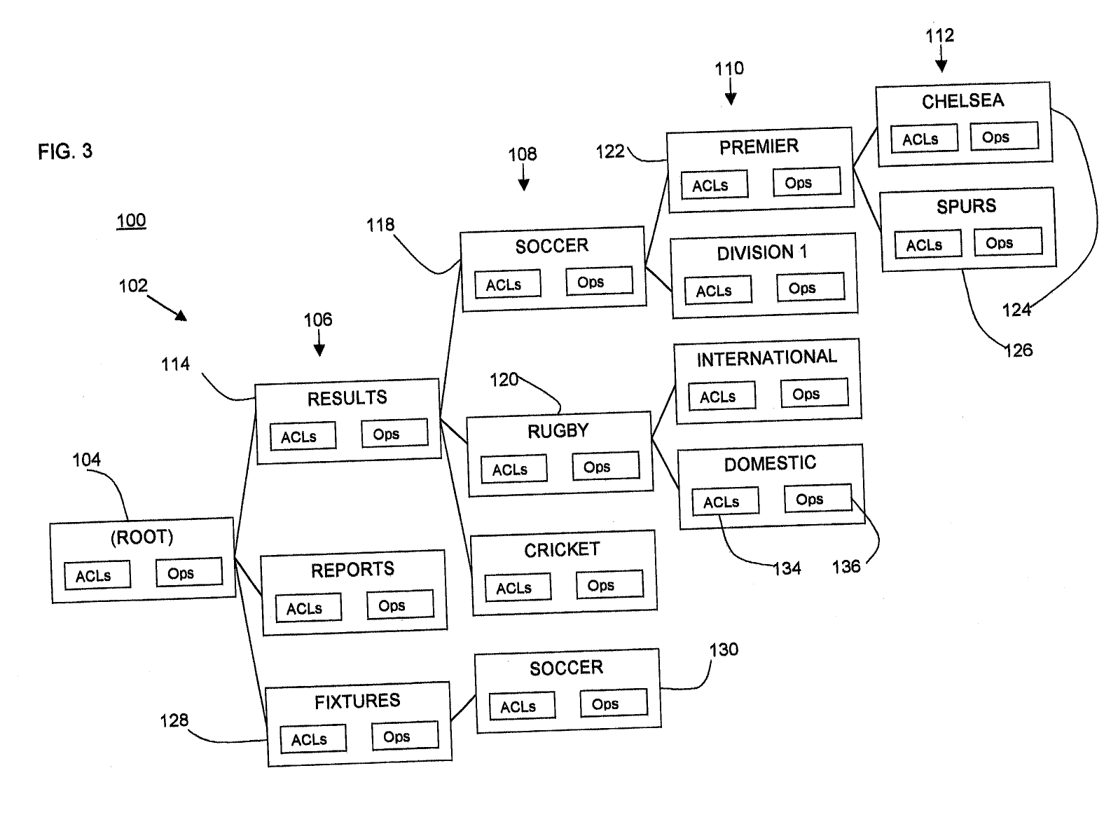

FIG. 3 shows a graphical user display 100 displaying a tree structure 102. The tree structure 102 is a horizontal structure in this example and has a root node 104 displayed as a box at the left hand extreme of the tree structure 102. The tree structure 102 has a first level of nodes 106 stemming from the root node 104. In this example there are three nodes in the first level 106. The tree structure 102 shown has a second level of nodes 108, a third level of nodes 110 and a fourth level of nodes 112.

In the first level of nodes 106, a top node 114 leads to three of the nodes of the second level of nodes 108. Of the three nodes of the second level 108, the top two nodes 118, 120 lead to two each of the nodes of the third level 110. The top node 122 of the third level leads to two nodes 124, 126 of the fourth level. In the first level of nodes 106, a bottom node 128 leads to one node 130 in the second level 108.

Each node of the tree structure 102 is displayed as a box with a title which identifies the topic of the node. In this example, the topics relate to sport with the first level 106 including the topics of “Results”, “Reports” and “Fixtures”. The second level 108 includes the types of sport, for example, “Soccer”, “Rugby” and “Cricket”. The third level 110 divides the sports into further categories, for example, soccer is divided into “Premier” and “Division 1” leagues and rugby is divided into “International” and “Domestic”. The fourth level 112 divides the sport categories into individual clubs, for example, the Premier league of soccer has clubs “Chelsea” and “Spurs”.

Each box of a node also includes an Access Control List button 134 and an Operation button 136 which will be described further below.

A tree structure 102 as shown in FIG. 3 has branches leading from the root node 104 to other nodes within the tree structure 102. For example there is a branch represented by the string “Root/Fixtures/Soccer” which includes nodes 104, 128 and 130 or “Root/Results/Rugby” or “Root/Results/Soccer/Premier/Chelsea”.

In this example, the tree structure 102 is a topic tree in a message broking system. Each node represents a topic of messages which principals can publish or subscribe to. The full set of Access Control Lists defined for users on all tonics in a broker system are imported into the system and displayed by means of the tree structure 102. The Access Control Lists for each topic are displayed by activating the ACL button 134 at a node of interest.

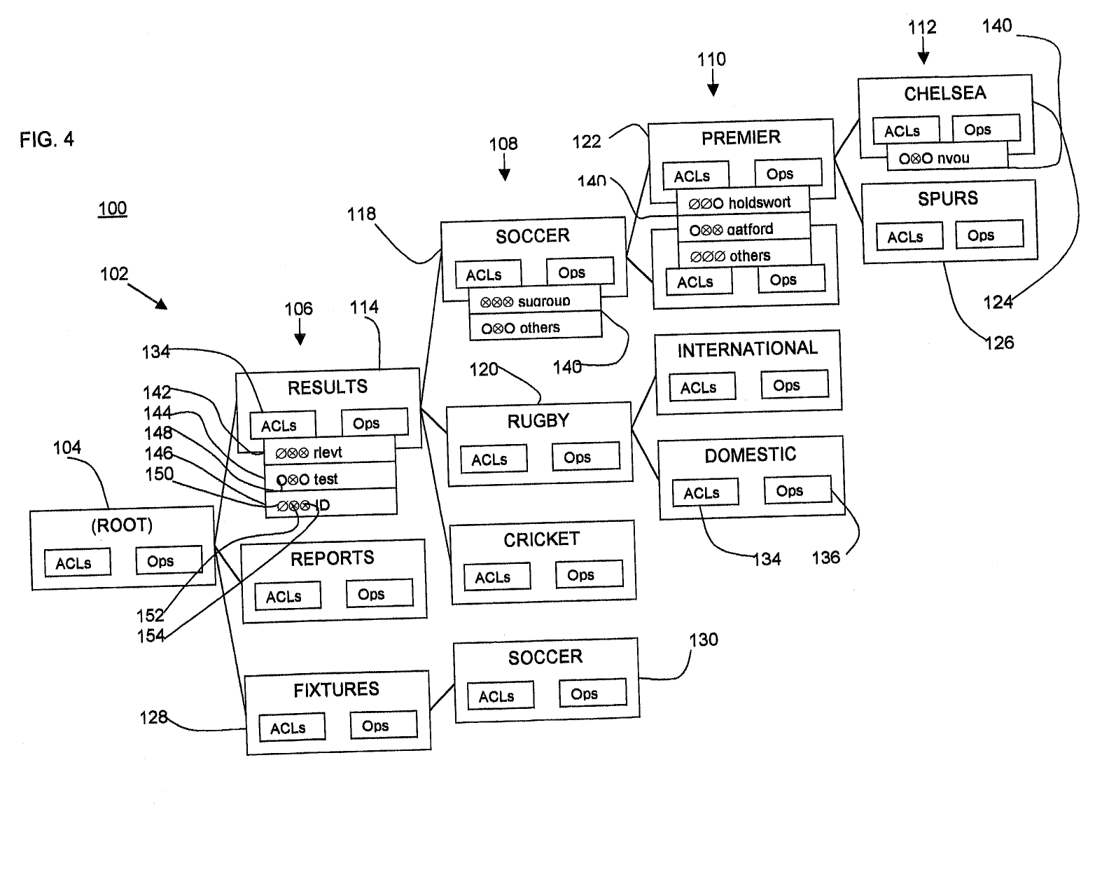

FIG. 4 shows the tree structure 102 of FIG. 3 with the ACL buttons 134 activated for each of the nodes 104, 114, 118, 122 and 124 of the branch “Root/Results/Soccer/Premier/Chelsea”.

On activation of the ACL button 134 of a node, for example node 114 with the title “Results”, which may be activated by clicking a cursor on the button in a Windows (Trade Mark) based environment, the ACLs defined for that node are displayed in a pop-up box 140. In node 114, three ACLs are shown in three boxes 142, 144, 146. Each box 142, 144, 146 has a name for the principal, for example “rlevt”, “test”, “ID”. The principal may be an individual user or a group of users which have one ACL for the whole group. Each box 142, 144 and 146 has symbols 148 indicating the status of the access control for that principal.

In this embodiment, the symbols are in the form of three traffic lights 150, 152 and 154 which represent the operations of “publish”, “subscribe” and “persistent” as related to a message broking system and as defined above. The symbols 150, 152 and 154 show whether the principal is allowed (green) or denied (red) the right to publish, subscribe or receive persistent messages on that topic. If the symbol is greyed out, then the ACL does not specify a permission for that operation. In this embodiment, traffic light symbols are used however it will be apparent to a person skilled in the art that other forms of symbols could be used with indications given in ways other than by colour, for example by pattern or symbol shape.

In the node 114, the group “rlevt” is denied the permission to publish messages on the topic of “Results” but is allowed the permission to subscribe persistently to messages. The group “test” has permission to subscribe to messages but no permission is specified for publication or for persistency.

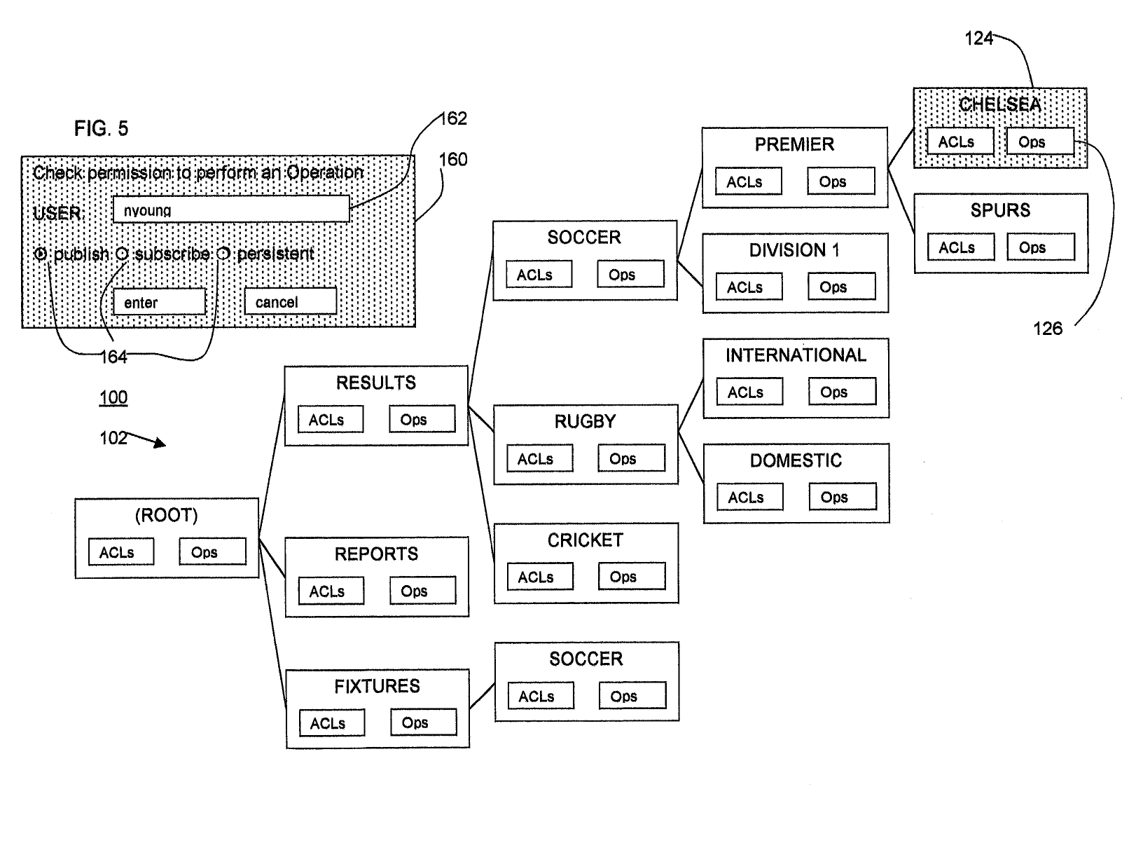

FIG. 5 shows the tree structure 102 as described in FIG. 3. The Operations button 126 in the node 124 which has the title “Chelsea” has been activated. The activation of the Operations button 126 results in the presentation of a dialog box 160 that allows the permission of a particular user to perform an operation on the topic associated with the node to be queried. The dialog box 160 and the node 124 to which it relates are both highlighted in a given colour or pattern.

The dialog box 160 allows a user to be specified in box 162 and the function to be queried to be chosen by selecting one of the buttons 164 relating to the functions of publish, subscribe and persistent. In FIG. 5, the principal “nyoung” has been specified and the function of publishing has been queried.

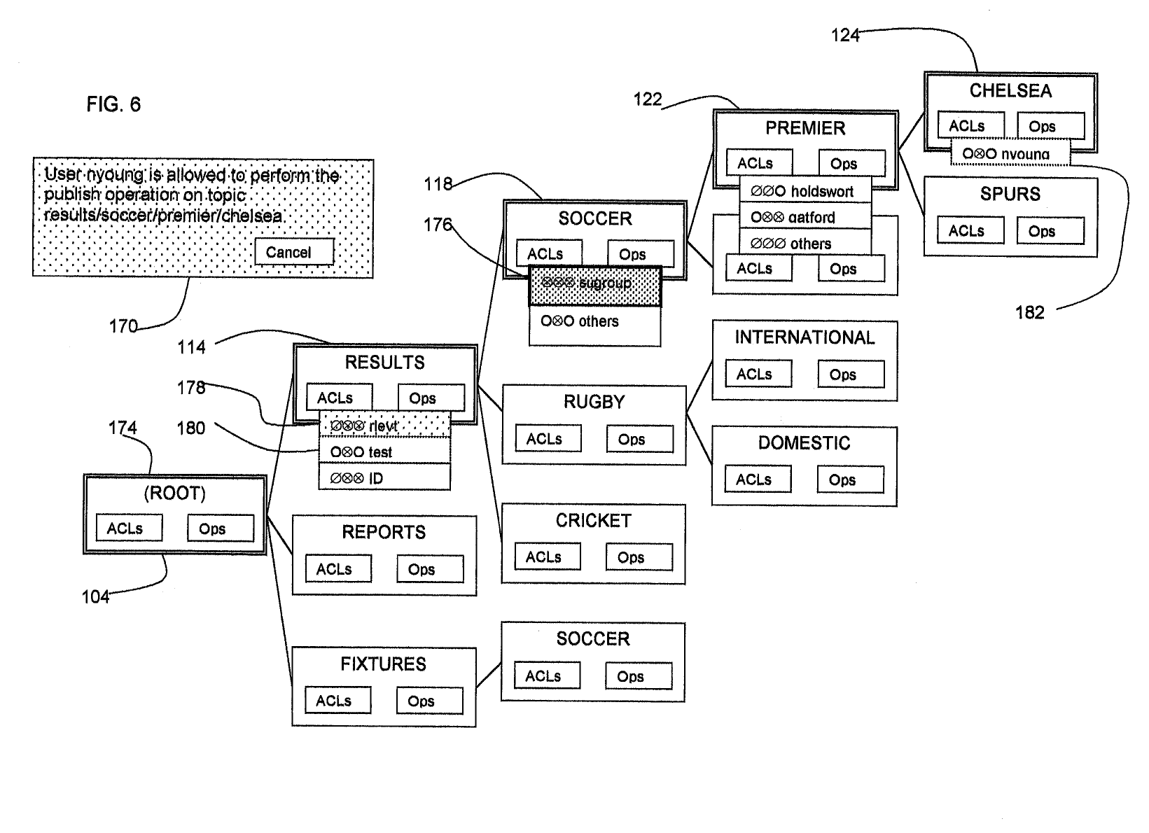

When the dialog box 160 is entered, the system will then perform a runtime function that traverses the tree 102, accumulating related ACLs and chooses the prevailing ACL according to a set of predefined rules. The result of the query is presented as shown in FIG. 6.

A dialog box 170 reports whether the operation would be allowed or denied. The dialog box 170 is highlighted. In this embodiment, the dialog box is highlighted in green if the operation is allowed and red if the operation is denied providing an immediate indication to an operator of the outcome of the query.

The relevant branch 174 in the tree structure 102 is highlighted in green (allowed) or red (denied) and all the ACLs on that branch 174 are displayed.

The prevailing ACL 176 whose policy determines the outcome of the operation is highlighted with a gold border and a bright red or green as appropriate (shown as a bold border and dense dots in the figure). This prevailing ACL 176 might be on any of the nodes in the relevant branch. In the illustrated embodiment, the prevailing ACL for the query regarding the publishing of the topic “Chelsea” for the principal “nyoung” is the ACL in node 118 for the principal or group “sugroup”. The principal “nyoung” is a member of the group of users “sugroup”. The highlighting in FIG. 6 is illustrated by shading and borders. Node 118 of the title “Soccer” allows the publishing of messages and this is the prevailing ACL for the principal “nyoung” in node 124 further along the branch 174 of the tree structure 102.

Other ACLs that are related to the permissions check are “lowlighted”. By “lowlighting” it is meant that the box for the ACL is highlighted but in a manner less obvious than the highlighting used for the prevailing ACL. For example, the principal might be a member of a group that has an ACL on a node that is closer to the root node than the prevailing ACL's node. Such an ACL would be lowlighted in a dull red or green as appropriate. This is illustrated in FIG. 6 by the ACL 178 in node 114. ACL 178 is for the group of users “rlevt” of which “nyoung” is also a member and this has permission to publish denied. However, the node 114 is closer to the root 104 than node 118 with the prevailing ACL 176 and therefore the ACL 178 in node 114 is lowlighted in dull red (shown as dots in the figure) to indicate that it is had a denied permission.

A related ACL 180 that is greyed-out for the specific operation is given a red and green border (shown as a dashed line in the figure). In FIG. 6, the ACL 180 of node 114 is the group of users “test” and has the publish symbol greyed-out. In other words there is no permission specified for the user (or group of users). Therefore, the ACL 180 is greyed-out, or has no highlighting, but has a border to identify that it is a related ACL. Similarly in FIG. 6, the ACL 182 for “nyoung” in node 124 has a border to show that it is related.

The tool could be enhanced in a number of ways:

The tool could support the online editing of ACLs.

The tool could allow the export of a set of ACLs.

The tool could support a “batch” mode that would allow the reporting of permission information for a user on all nodes in the tree (or for a subtree).

The tree could support the collapsing or expansion of subtrees.

The tool could be integrated with the MQSeries Integrator v2 Control Center.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

What is claimed is:

1. A method for display of access control in a graphical user interface (100) including:
displaying resources in a tree structure (102) having a plurality of nodes (104, 114, 120 . . . ), each node representing a resource and each resource having the potential for one or more users in relation to one or more actions on the resource; and
selectively displaying, in association with a node, permission to perform an action (134) on a resource by a principal, wherein the principal is an individual user or a group of users.

2. A method as claimed in claim 1, wherein the method includes displaying the result of a query (160) relating to permission to perform an action on a specified resource for a principal (182) within the tree structure (102).

3. A method as claimed in claim 2, wherein the method includes displaying how the result of the query was obtained.

4. A method as claimed in claim 2, wherein displaying the result of the query includes highlighting a branch (174) of the tree structure (102) including the node (124), the highlighting indicating the outcome of the result.

5. A method according to claim 4, including displaying an access control list entry for the principal (182) which entry is associated with the node.

6. A method as claimed in claim 4, wherein the method includes displaying access control lists for principals at all nodes (104, 114, 118, 122, 124) on the highlighted branch (174).

7. A method as claimed in claim 2, wherein the method includes identifying by a first means the access control list (176) that determines the outcome of the result of the query (160).

8. A method as claimed in claim 2, wherein any principal related access control lists (178) which do not determine the outcome of the result are identified by a second means.

9. A method as claimed in claim 7, wherein the identifying by first and second means is by means of highlighting, borders, colour, patterns or other means to distinguish from other access control list displays and wherein the first and second means are different.

10. A method as claimed in claim 2, wherein access control for principals is displayed with symbols (148) indicating the status of the control permission for given activities relating to the resource.

11. A method as claimed in claim 10, wherein the symbols (148) are traffic lights with colour indications of the status of the control permission.

12. A method as claimed in claim 2, wherein the method includes running a runtime function to traverse the tree structure (102) accumulating access control lists relating to the principal (182) and choosing the determining access control list (176) according to a set of predetermined rules.

13. A method as claimed in claim 12, wherein the predetermined rules include inherited access control and specific access control rules.

14. A method as claimed in claim 1, wherein the resources are topics in a message broking system and access control relates to the publishing and subscribing to messages.

15. An apparatus for display of access control in a graphical user interface including:
a display of resources in a tree structure (102) having a plurality of nodes (104, 114, 118, 120 . . . ), each node representing a resource and each resource having the potential for one or more users in relation to one or more actions on the resource; and
means for selectively, in association with a node, displaying permission to perform an action (134) on a resource by a principal, wherein the principal is an individual user or a group of users.

16. An apparatus as claimed in claim 15, including means for displaying the result of a query (160) relating to permission to perform an action on a specified resource for a principal (182) within the tree structure (102).

17. An apparatus as claimed in claim 16, including means for displaying how the result of the query was obtained.

18. An apparatus as claimed in claim 15, wherein the means for displaying the result of the query includes a means for highlighting a branch (174) of the tree structure (102) including the node (124) principal (182), the highlighting indicating the outcome of the result.

19. An apparatus as claimed in claim 18, including means for highlighting an access control list entry for the principal (182) which entry is associated with the node.

20. An apparatus as claimed in claim 18, including a display of access control lists for principals at all nodes (104, 114, 118, 122, 124) on the highlighted branch (174).

21. An apparatus as claimed in claim 16, including means for identifying by a first means the access control list (176) that determines the outcome of the result of the query (160).

22. An apparatus as claimed in claim 16, wherein any principal related access control lists (178) which do not determine the outcome of the result are identified by a second means.

23. An apparatus as claimed in claim 20, wherein the means for identifying by first and second means is by means of highlighting, borders, colour, patterns or other means to distinguish from other access control list displays and wherein the first and second means are different.

24. An apparatus as claimed in claim 16, including displays of access control for principals in the form of symbols (148) indicating the status of the control permission for given activities relating to the resource.

25. An apparatus as claimed in claim 24, wherein the symbols (148) are traffic lights with colour indications of the status of the control permission.

26. An apparatus as claimed in claim 16, including a runtime function to traverse the tree structure (102) accumulating access control lists relating to the principal (182) and means for choosing the determining access control list (176) according to a set of predetermined rules.

27. An apparatus as claimed in claim 26, wherein the predetermined rules include inherited access control and specific access control rules.

28. An apparatus as claimed in claim 16, wherein the resources are topics in a message broking system and access control relates to the publishing and subscribing to messages.

29. A computer program product stored on a computer readable storage medium comprising computer readable program code means for performing the steps of:
displaying resources in a tree structure having a plurality of nodes, each node representing a resource and each resource having the potential for one or more users in relation to one or more actions on the resource;
selectively displaying permission to perform an action on a resource by a principal; wherein the principal is an individual user or a group of users.
